(19) United States
(12) Patent Application Publication
(10) Pub. No.: US 2007/0272051 A1
(43) Pub. Date: Nov. 29, 2007

(54) Torque Rod Structure

(76) Inventors: Naoyuki Kamei, Tokyo (JP); Hiroshi Kojima, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/574,497

(22) PCT Filed: Oct. 1, 2004
(86) PCT No.: PCT/JP04/14492

§ 371 Date: Apr. 19, 2007

(30) Foreign Application Priority Data
Oct. 3, 2003 (JP) 2003-345741

(51) Int. Cl. F16C 7/02

(52) U.S. Cl. 74/579 R

(57) ABSTRACT

The invention aims to provide a torque rod which, by adding an improved rod portion, has not only compression and tensile strength, but also increased bending and twisting stiffness. By the present invention, the twisting stiffness can be raised to 2 to 3 times that of a conventional rib shape.

A torque rod, the torque rod structure comprising a rod portion with a built-in pair of rubber bushes, which are formed respectively around a pair of cylinders, the rod portion linking both the rubber bushes, wherein the cross-sectional shape of the central portion of the rod portion forms a rectangular shape and one pair of opposing edges of the rectangular shape form a shape which bulges outwards, and the cross section of the rod portion is one of a hollow portion, honey comb shape, or rib structure. 11, 12 . . . internal cylinders, 20 torque rod, 21 . . . hollow portion.

### TECHNICAL FIELD

The present invention relates to a torque rod for arresting the movement of an engine of a motor vehicle, and related to improving torque rods made of resin or metal that connect a pair of rubber bushes or cylinders.

### BACKGROUND ART

Conventionally with torque rods, there is, as shown in FIG. 1A, a torque rod 10, connecting a pair of rubber bushes 3,4 and cylinders 1,2, is usually made of resin, iron or aluminum. The core of the rod portion is either a rectangular cross-sectional shape or H section cross section ribbed structure (see FIG. 1B and the patent publication reference 1). 6 are hollow portions, 5,8 are rubber stoppers, 9 is a rib formed on the surface. FIG. 1B is the cross section of FIG. 1A at the line “a-a”.

However, for such a torque rod 10, whilst this can satisfy the requirements in terms of raising the compression strength and tensile strength, it is not a shape which takes into account other requirements. For example, the current situation is that the demands in recent years for bending stiffness and twisting stiffness are not adequately provided for. That is, conventionally in the shape of torque rods connecting cylindrical rubber bushes, a rib is put on the surface, and by doing so the aimed for compression and tensional strength can be achieved. However, against bending and twisting, the secondary moment and section modulus is lowered, and, for example, it is pointed out that the twisting stiffness cannot be increased.

Patent Publication Reference 1: Japanese Patent Application Laid-Open No. 10-299805.

### DISCLOSURE OF THE INVENTION

### Problems Addressed by the Invention

The invention is made to solve the above problems, and addresses the requirements by providing an improved shape of the rod portion with increased stiffness to bending and twisting.

### Means of Solving the Problems

A first aspect of the invention is a torque rod comprising a built-in pair of rubber bushes formed respectively around a pair of cylinders, and a rod portion, which links both rubber bushes, wherein the rod portion has a hollow cross-sectional shape.

A second aspect of the invention is a torque rod comprising a built-in pair of rubber bushes formed respectively around a pair of cylinders, and a rod portion, which links both rubber bushes, wherein the rod portion is formed with plural void portions.

A third aspect of the invention is a torque rod comprising a built-in pair of rubber bushes formed respectively around a pair of cylinders, and a rod portion, which links both rubber bushes, wherein the rod portion is formed with cross-shaped ribs.

### EFFECT OF THE INVENTION

The invention has a configuration which is one of the above torque rod structures, and in all of the configurations by adding the great improvement in the rod portion, not only does the torque rod have compression and tensional strength, but also significantly increased bending and twisting stiffness. Specific structures include a rod portion with a hollow structure (the first aspect), plural void (honeycomb) structure (the second aspect), or rib structure (the third aspect). By these structures, and further by preferably thickening the central cross-section, the twisting stiffness can be increased to 2 to 3 times that of a conventional ribbed shape.

### BRIEF DESCRIPTION OF THE DRAWINGS

FIG. 1A is a diagram showing a structure of a conventional torque rod.

FIG. 1B is a diagram showing a structure of a conventional torque rod.

FIG. 2 is a front view of a torque rod of the first aspect of the invention.

FIG. 3 is a side view of the torque rod of FIG. 2.

FIG. 4 is a cross-section taken on the line A-A of FIG. 2.

FIG. 5 is a cross-section taken on the line B-B of FIG. 3.

FIG. 6 is a cross-section taken on the line C-C of FIG. 4.

FIG. 7 is a front view of a torque rod of the second aspect of the invention.

FIG. 8 is a side view of the torque rod of FIG. 7.

FIG. 9 is a cross-section taken on the line D-D of FIG. 7.

FIG. 10 is a cross-section taken on the line E-E of FIG. 8.

FIG. 11 is a cross-section taken on the line F-F of FIG. 10.

FIG. 12 is a front view of a torque rod of the third aspect of the invention.

FIG. 13 is a side view of the torque rod of FIG. 12.

FIG. 14 is a cross-section taken on the line G-G of FIG. 12.

FIG. 15 is a cross-section taken on the line H-H of FIG. 13.

FIG. 16 is a cross-section taken on the line I-I of FIG. 13.

FIG. 17 is a cross-section taken on the line J-J of FIG. 13.

FIG. 18 is another example of a cross-section similar to FIG. 17.

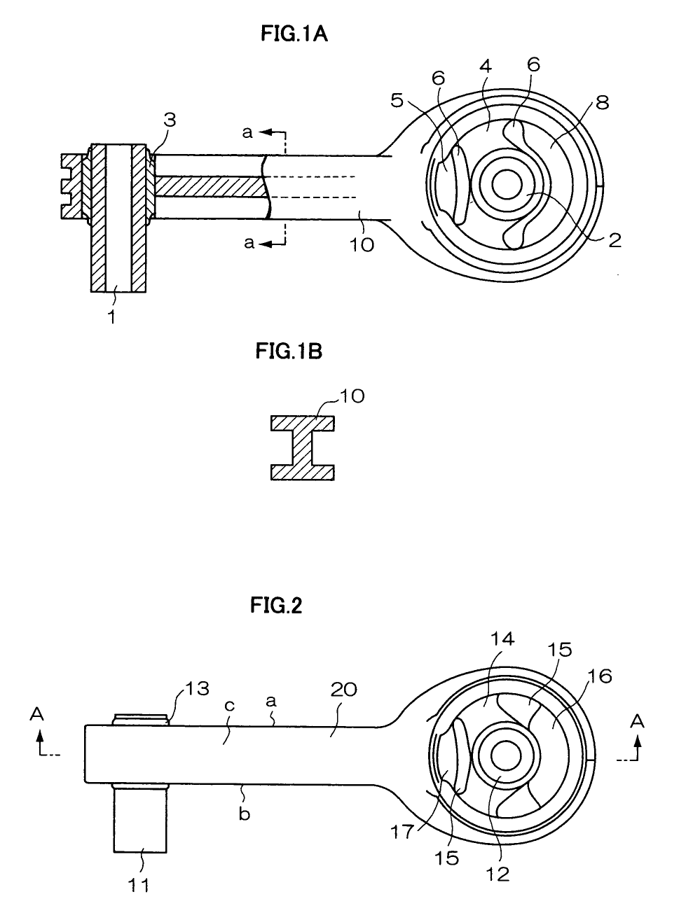

### BEST MODE FOR CARRYING OUT THE INVENTION

The torque rod of the invention is a torque rod which is made of resin or metal, for example cast iron or aluminum. The invention includes a rod portion (1) made with a hollow structure (the first aspect of the invention), (2) formed with plural void portions (the second aspect of the invention), and (3) with plural hole portions forming cross-shaped ribs (the third aspect of the invention), to improve the twisting and bending stiffness of the rod portion. It is preferable that further, in the invention, a structure is included wherein the central cross-section of the rod portion is made thicker than the ends thereof, and the like. By such structures, the above aims can be achieved (improvement in the twisting and bending stiffness of the rod portion).

For the material to configure the torque rod, this can be, for example, made of metals, typically iron or aluminum alloys, or made of resins called engineering plastics, and amongst these polyamide is the most preferable applicable.

In the above first aspect, the torque rod can be manufactured by a resin or aluminum casting method and at the same time, for example, a processing method such as a core method or AGI processing method can be used to form the hollow center. By these methods, a conventional cast portion is made hollowed out to become a thick walled rod portion, and it is most appropriate that by making the central cross-section of the rod portion thicker relative to that of the two ends, the polar moment of inertia of area and the polar modulus of section can be increased, making it possible to yield an increase in strength together with a reduction in weight.

For example, if the internal size of the hollow portion is made half the external size of the rod portion, then the twisting angle and maximum sheer strain r max becomes 6% greater than for a central shaft of the same external diameter, the weight becomes reduced by 25%. That is, by being a hollow structure, it becomes possible to improve weight reduction and twisting stiffness in the same space.

When it is not possible to directly form a hollow shape, then it goes without saying that it is possible to achieve the purpose by forming three faces in a “U” shape cross-section, forming the remaining face as a separate body, and forming a hollow shape structure by welding it on as a cap.

The second aspect and third aspects are preferably used when, due to constraints in the mould release construction and the like, the torque rod cannot be one of a hollow construction, and have a construction which can be removed from the mould in one direction or both directions. This construction, in order to increase the polar modulus of section, results in a rod portion in a comb shape or lattice shape (cross-shaped ribs). In these constructions too, of course, a bulging central portion of the rod is also preferable.

### EXAMPLE 1

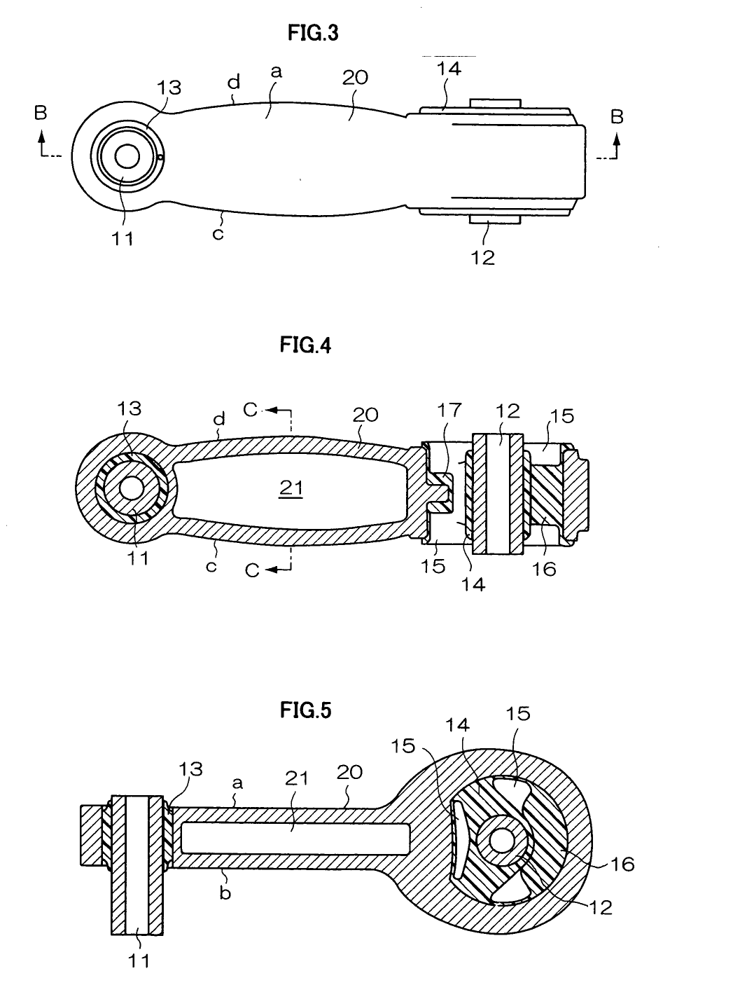

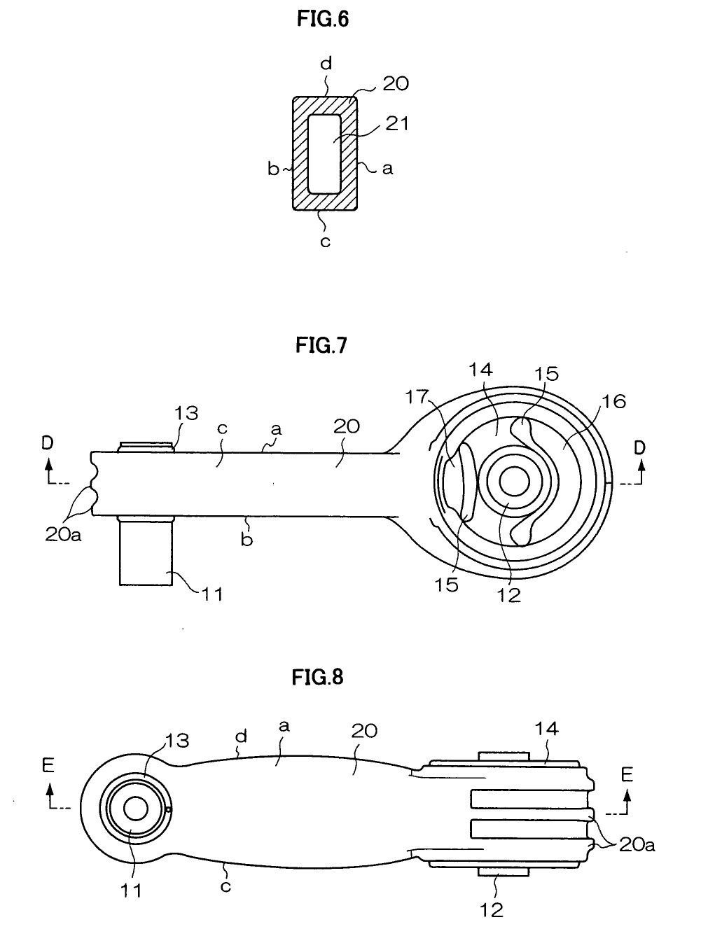

FIGS. 2 to 6 are examples of the first invention, FIG. 2 is a front view, FIG. 3 is a side view, FIG. 4 is a cross-section on the line A-A, FIG. 5 is a cross-section on the line B-B, FIG. 6 is a cross-section on the line C-C. The numerals 11,12 are a pair of internal cylinders disposed at 90 degrees to each other, 13 is a rubber bush which covers the internal cylinder 11, 14 is a rubber bush which covers the internal cylinder 12, 15 is a hollow portion formed on the inner and outer sides of the internal cylinder 12, and stoppers 16,17 are provided sandwiched by the hollow portion 15. The torque rod 20 made of a polyamide resin is connected thereto.

Because the internal cylinder 11 is surrounded by rubber bush 13 it does not move, but the other internal cylinder 12 is comparatively free to move because of the hollow portion 15, and in this case, the movement thereof becomes regulated by impacting with the stoppers 16, 17.

The torque rod 20 is approximately rectangular in cross-section on the line B-B, and the corresponding faces “a” and “b” are formed parallel. Faces “c” and “d” form a shape in which the central portion bulges, and the hollow portion 21 is inside this portion.

By this shape, the bending stiffness and twisting stiffness each become about three times that of a conventional torque rod.

### EXAMPLE 2

Now, in cases where the hollow portion 21 cannot be made by casting as with aluminum alloy, whilst it is not illustrated, it goes without saying that the cross-section on C-C can be preliminary made as a “U” section, and then the hollow portion 21 can be formed by using a flat plate as a cap for the remaining face.

### EXAMPLE 3

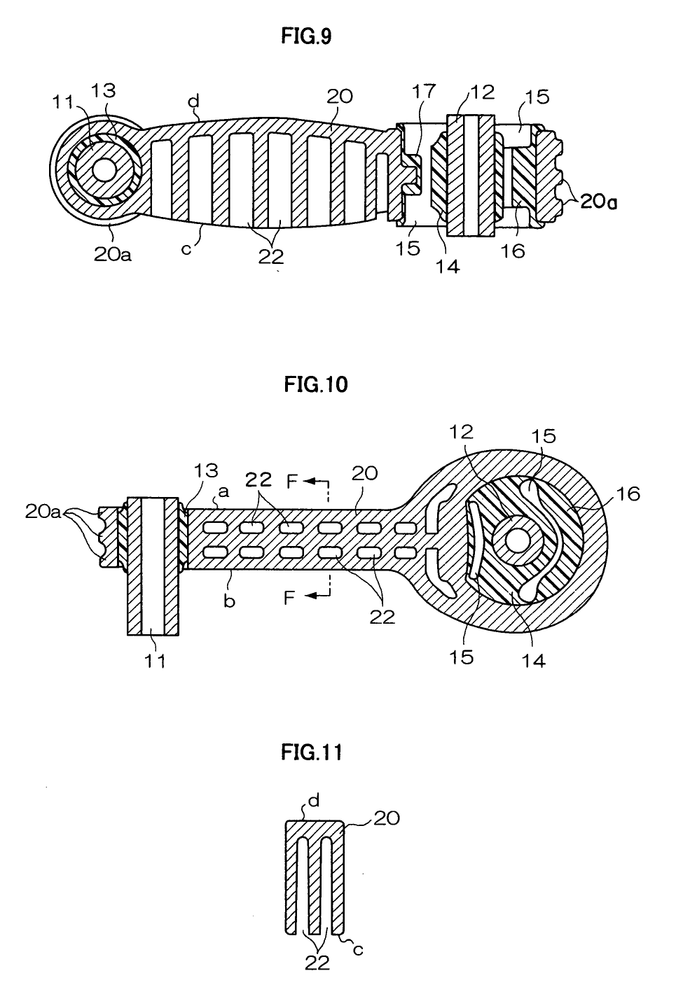

FIGS. 7 to 11 are examples of the second invention, FIG. 7 is a front view, FIG. 8 is a side view, FIG. 9 is a cross-section on the line D-D, FIG. 10 is a cross-section on the line E-E, and FIG. 11 is a cross-section on the line F-F. The numerals 11 to 17 are the same as in the previous examples and the explanation thereof will be omitted.

The torque rod 20 made of polyamide is approximately rectangular in cross-section on the line B-B, and the corresponding faces “a” and “b” are formed parallel. Faces “c” and “d” form a shape in which the central portion bulges, and the on the face “c” two rows of void portions 22 are formed. 20a is a rib formed on the outer periphery of the torque rod 20.

By having such a shape, the bending stiffness and twisting stiffness each become about twice that of a conventional torque rod.

### EXAMPLE 4

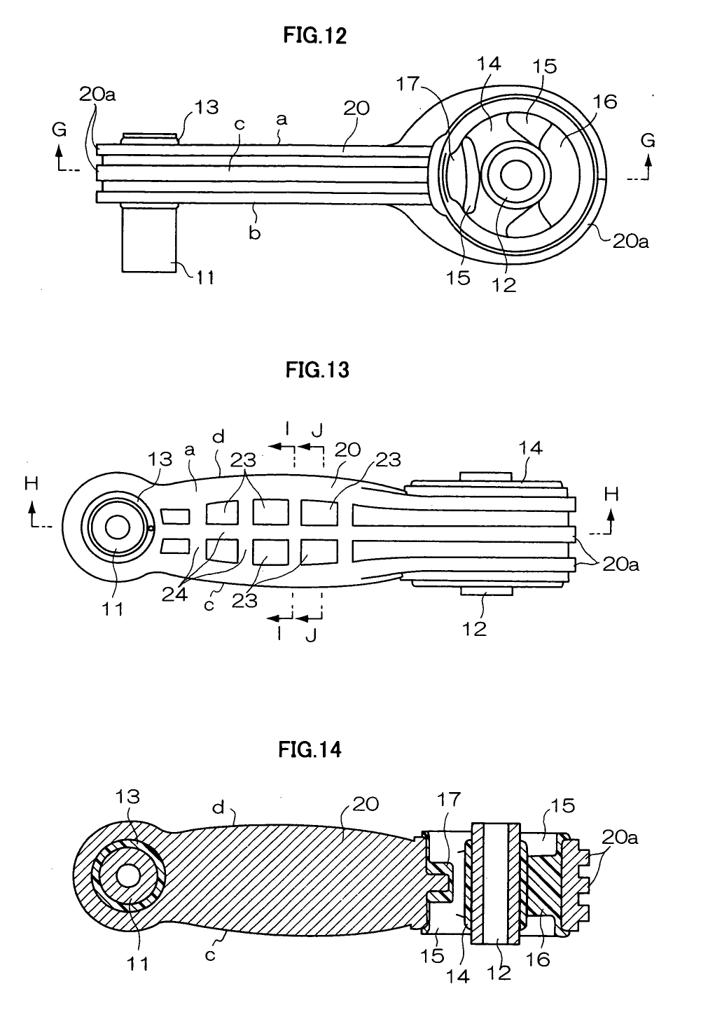

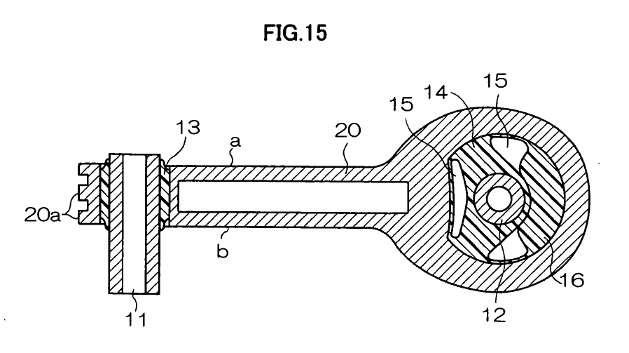

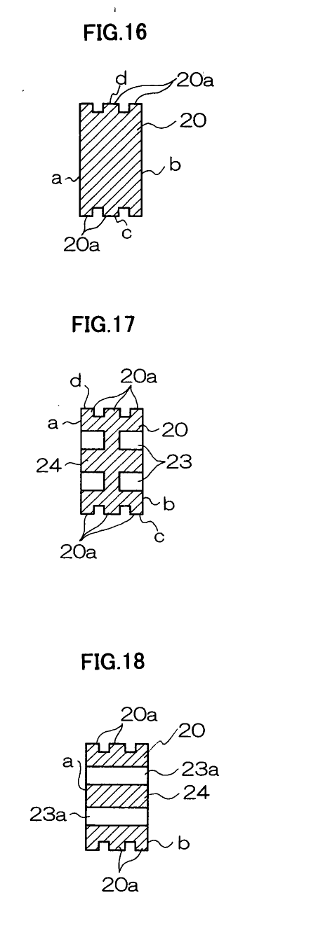

FIGS. 12 to 17 are examples of the second invention, FIG. 12 is a front view, FIG. 13 is a side view, FIG. 14 is a cross-section on the line G-C, FIG. 15 is a cross-section on the line H-H, FIG. 16 is a cross-section on the line I-I, and FIG. 17 is a cross-section on the line J-J. The numerals 11 to 17 are the same as in the previous examples and the explanation thereof will be omitted.

The torque rod 20 made of polyamide is approximately rectangular in cross-section on the line B-B, and the corresponding faces “a” and “b” are formed parallel. Faces “c” and “d” form a shape in which the central portion bulges, and on the parallel faces “a” and “b” two rows of blind holes 23 are formed. Overall, cross-shaped ribs 24 are formed.

By having such a shape, the bending stiffness and twisting stiffness each become about 2.5 times that of a conventional torque rod.

### EXAMPLE 5

The cross-shaped ribs 24 can be formed, as shown in FIG. 18, by forming through holes 23a in place of the blind holes 23 (that is, it is possible to form the torque rod 20 in a honey comb configuration with through holes).

### INDUSTRIAL APPLICABILITY

As described above, in the invention, by changing the construction of a torque rod, the bending stiffness and twisting stiffness can be greatly improved, and these rods are applicable not only in the field of torque rods for motor vehicles but in a great number of fields. The range of applicability is extremely wide.

### EXPLANATION OF NUMERALS

| | |
|---|---|
| 11,12 | Internal Cylinders |
| 20 | Torque Rod |
| 21 | Hollow Portion |
| 22 | Void Portions |
| 23 | Blind Holes |
| 23a | Through Holes |
| 24 | Cross-Shaped Ribs |

1. A torque rod, the torque rod structure comprising a rod portion with a built-in pair of rubber bushes, which are formed respectively around a pair of cylinders, the rod portion linking both the rubber bushes, wherein the rod portion has a hollow cross-sectional shape.

2. The torque rod structure according to claim 1, wherein the rod portion is formed from three faces which are integrally formed as a U-section that is capped by a face connected on one side thereof.

3. The torque rod structure according to claim 1, wherein the rod portion has a shape in which the central portion thereof bulges outwards.

4. The torque rod structure according to claim 3, wherein the cross-sectional shape of the central portion of the rod portion forms a rectangular shape, and one pair of opposing edges of the rectangular shape form a shape which bulges outwards.

5. A torque rod, the torque rod structure comprising a rod portion with a built-in pair of rubber bushes, which are formed respectively around a pair of cylinders, the rod portion linking both the rubber bushes, wherein the rod portion is shaped with a plurality of void portions.

6. The torque rod structure according to claim 5, wherein the rod portion has a shape in which the central portion thereof bulges.

7. The torque rod structure according to claim 5, wherein the cross-sectional shape of the central portion of the rod portion forms a rectangular shape, and one pair of opposing edges of the rectangular shape form a shape which bulges at the middle, and the void portions are formed on the bulging edges.

8. A torque rod, the torque rod structure comprising a rod portion with a built-in pair of rubber bushes, which are formed respectively around a pair of cylinders, the rod portion linking both the rubber bushes, wherein cross-shaped ribs are formed on the rod portion.

9. A torque rod, the torque rod structure comprising a rod portion with a built-in pair of rubber bushes, which are formed respectively around a pair of cylinders, the rod portion linking both the rubber bushes, wherein the cross-section shape of at least the central portion of the rod portion is rectangular, and the shape of the cross-section in the vicinity of the central portion has along the longitudinal direction of the rod portion either a continuous hollow, or a series of alternate cross-sections which have a notched portion and cross-sections which do not have a missing portion.

10. The torque rod structure according to claim 9, wherein one pair of opposing edges of the rectangular shape form a shape which bulges towards the outside.

11. The torque rod structure according to claim 9, wherein the cross-section shape of the rod portion has along the longitudinal direction of the rod portion a continuous hollow.

12. The torque rod structure according to claim 11, wherein the rod portion is formed from three faces which are integrally formed as a U-section and a side face which connects thereto as a cap.

13. The torque rod structure according to claim 11, wherein the rod portion has a shape in which the central portion thereof bulges outwards.

14. The torque rod structure according to claim 9, wherein the rod portion is shaped with a plurality of void portions.

15. The torque rod structure according to claim 14, wherein the void portions correspond to the notched portions.

16. The torque rod structure according to claim 14, wherein the rod portion has a shape in which the central portion thereof bulges outwards

17. The torque rod structure according to claim 14, wherein one pair of opposing edges of the rectangular of cross-sectional shape form a shape which bulges towards the outside, and the notched portions are formed on the bulging edges.

18. The torque rod structure according to claim 9, wherein cross-shaped ribs are formed on the rod portion.

19. The torque rod structure according to claim 18, wherein the rod portion has a shape in which the central portion thereof bulges outwards.

20. The torque rod structure according to claim 18, wherein the rod has a honey comb shape.
